(19) United States
(12) Patent Application Publication
(10) Pub. No.: US 2021/0376405 A1
(43) Pub. Date: Dec. 2, 2021

(54) THERMAL BARRIER MATERIAL FOR ELECTRIC VEHICLE BATTERY APPLICATIONS

(71) Applicant: 3M INNOVATIVE PROPERTIES COMPANY, St. Paul, MN (US)

(72) Inventors: Rhesa M. Browning, Austin, TX (US); Jennifer K. Pratt, Round Rock, TX (US); Stephen D. Daniell, Round Rock, TX (US); David D. Lu, Austin, TX (US); Mitchell T. Huang, Austin, TX (US); Wei Zhou, Shanghai (CN); Lei Guo, Shanghai (CN)

(21) Appl. No.: 17/250,948

(22) PCT Filed: Oct. 24, 2019
(86) PCT No.: PCT/CN2019/112963

§ 371 Date: Apr. 1, 2021

Related U.S. Application Data
(60) Provisional application No. 62/750,550, filed on Oct. 25, 2018.

(51) Int. Cl. H01M 10/658; H01M 10/0525; B32B 5/02; B32B 5/18; B32B 19/04; B32B 7/12; B32B 15/14; B32B 15/04

(52) U.S. Cl. CPC H01M 10/658; H01M 10/0525; B32B 5/022; B32B 5/18; B32B 19/041; B32B 7/12; B32B 2457/10; B32B 15/046; B32B 2307/3065; B32B 2307/732; B32B 2307/302; B32B 2250/05; B32B 2250/40; B32B 15/14

(57) ABSTRACT

A composite thermal barrier material for use in electric and hybrid vehicle battery packs is described herein. The composite material comprises a porous core layer, a pair of flame retardant layers disposed on either side of the porous core layer, and at least one radiant barrier layer disposed between the porous core layer and one of the pair of flame retardant layers. In some exemplary embodiments, the porous core layer is a thermally expandable layer.

### BACKGROUND

The present invention is directed to a thermal barrier material for use in electric vehicles. In particular, the exemplary thermal barrier material is a composite material comprising a pair of flame retardant materials layers disposed on either side of a porous core layer and at least one radiant barrier layer disposed between one of the flame retardant materials layers and the porous core layer.

The growth in hybrid and electric vehicles is being fueled by consumers seeking efficient, environmentally friendly personal transportation options. Electrical vehicle manufacturers are striving to improve the efficiency of their vehicles by increasing the vehicle range per battery charge and the battery charging rate by creating more energy dense lithium ion battery designs. Increasing energy densities in the lithium ion battery packs has created a need for containing the potential dangers associated with battery failures. When lithium ion batteries fail, they can undergo “thermal runaway”, where the ionic solution in the battery cells boils, burns through the outer pack, which may cascade to adjacent cells. This cascade reaction can lead to failure of the whole battery array within 5-10 minutes and result in a vehicle fire.

In order to prevent or significantly delay this phenomenon, electric vehicle manufacturers are deploying thermal runaway barrier materials which can provide a physical and thermal barrier between adjacent battery packs. One conventional approach is to use mica boards in this application as a thermal barrier material. While mica boards (e.g., boards including at least 80% mica) are excellent thermal barrier materials, they are not ideal for some electric vehicle applications. The high density of mica boards can make mica boards a less attractive solution for electric vehicle battery applications desiring lighter weight materials.

Electric vehicle manufacturers want a barrier material having a larger thermal gradient, so that the temperature of the face of the thermal barrier opposite the cell in thermal runaway is significantly cooler than the temperature of the face of the thermal barrier facing the cell in thermal runaway (e.g. more than 50% cooler, preferably more than 35% cooler). Some electric vehicle manufacturers want a barrier material having a larger thermal gradient, so that the face of the thermal barrier opposite the cell in thermal runaway is less than 140° C., preferably less than 120° C. Additionally, the space allowed for thermal barrier materials in many electric vehicles can be quite limited (e.g., less than 5 mm) which restricts the use of many thicker thermal barrier materials.

Thus, there is a need for thermal barrier materials that are thin, lightweight materials that provide a high thermal gradient across the material when exposed to high temperature on one side of the material.

### BRIEF SUMMARY

A composite thermal barrier material for use in electric and hybrid vehicle battery packs is described herein. The composite material comprises a porous core layer, a pair of flame retardant layers disposed on either side of the porous core layer, and at least one radiant barrier layer disposed between the porous core layer and one of the pair of flame retardant layers.

In some embodiments, the composite material can comprise a first radiant barrier layer adjacent to a first major surface of the porous core layer and a first flame retardant layer disposed on a surface of the first barrier layer opposite the porous core layer, a second radiant barrier layer disposed adjacent to a second major surface of the porous core layer and a second flame retardant layer disposed on a surface of the second barrier layer opposite the porous core layer.

In another embodiment, a thermal barrier composite material is disclosed that comprises a porous core layer, wherein the porous core layer is a thermally expandable layer having first and second major surfaces, a radiant barrier layer disposed on the first major surface of the thermally expandable layer, and a flame barrier layer disposed on a second surface of the radiant barrier layer opposite the thermally expandable layer.

In a third embodiment, a thermal barrier composite material is disclosed that comprises a porous core layer, wherein the porous core layer is a thermally expandable layer having first and second major surfaces, a first flame barrier layer disposed on the first major surface of the thermally expandable layer, a radiant layer disposed on a second major surface of the thermally expandable layer and a second layer flame barrier layer disposed on the radiant layer opposite the thermally expandable layer. The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIG. 1 is a schematic cross-section of a first embodiment of a thermal barrier composite material according to the present invention.

FIG. 2 shows an exemplary battery module that includes a thermal barrier comprising thermal barrier composite material disposed between the battery cells and as an outer wrap for the module according to an aspect of the invention.

FIG. 3 shows an exemplary battery pack having a plurality of battery modules that includes a thermal barrier comprising thermal barrier composite material disposed as an outer wrap around each of the plurality of modules and as a thermal barrier cover disposed on top of each module according to an aspect of the invention.

FIG. 4 shows an exemplary battery pack having a thermal barrier cover comprising thermal barrier composite material disposed over all the modules in the battery pack according to an aspect of the invention.

FIG. 5 is a schematic diagram illustrating the test method for determining the heat flow through an exemplary thermal barrier composite material of the present invention.

FIG. 6 is a schematic cross-section of an embodiment of thermal barrier composite material according to the present invention.

FIG. 7 is a schematic cross-section of another embodiment of thermal barrier composite material according to the present invention.

FIG. 8 is a schematic cross-section of a third embodiment of thermal barrier composite material according to the present invention.

### DETAILED DESCRIPTION

In the following Detailed Description, reference is made to the accompanying drawings, which form a part hereof, and in which is shown by way of illustration specific embodiments in which the invention can be practiced. In this regard, directional terminology, such as “top,” “bottom,” “front,” “back,” “forward,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments can be utilized, and structural or logical changes can be made without departing from the scope of the present invention. The following detailed description, therefore, is not to be taken in a limiting sense, and the scope of the present invention is defined by the appended claims.

The present invention is directed to a thermal barrier material for use in electric vehicles. In particular, the exemplary thermal barrier material is a composite material comprising a pair of flame retardant/barrier materials layers disposed on either side of a porous core layer and at least one radiant barrier layer disposed between one of the flame retardant/barrier materials layers and the porous core layer.

The exemplary thermal barrier composite materials, describe herein, provide a high thermal gradient or temperature drop across the material (e.g. from the front side to the back side) when exposed to torch fire on the front side of the material. The exemplary thermal barrier material of the present invention may prevent or slow heat from flowing from a failing cell or module to an adjacent cell or module or into the passenger compartment.

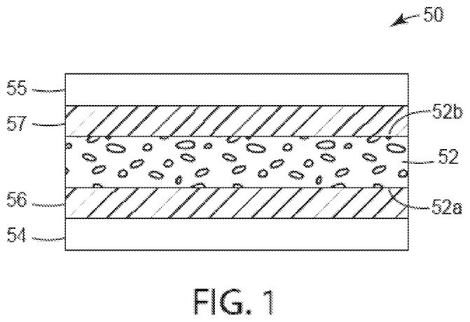

For example, FIG. 1 shows a first embodiment of a thermal barrier composite material 50. Thermal barrier composite material 50 has a porous core layer 52 having first and second major surfaces 52a, 52b, respectively. A pair of flame retardant materials layers 54, 55 are disposed on either side of porous core layer 52 and at least one radiant barrier layer can be disposed between one of the flame retardant materials layers and the porous core layer. The exemplary porous core layer comprises air (e.g. air voids) distributed throughout the body of the porous core layer. The presence of air in the porous core layer improves the thermal insulating properties of the resulting composite material.

The embodiment shown in FIG. 1, comprises two radiant layers 56, 57. A first radiant barrier layer 56 is disposed adjacent to the first major surface 52a of porous core layer 52 with first flame retardant layer 54 disposed adjacent to a surface of the first barrier layer opposite the porous core layer. Similarly, a second radiant barrier layer 57 is disposed adjacent to the second major surface 52b of the porous core layer with second flame retardant layer 55 disposed adjacent to a surface of the second barrier layer opposite the porous core layer. In some aspects of the exemplary thermal composite materials described herein, the porous core layer 52 can be a thermally expandable layer.

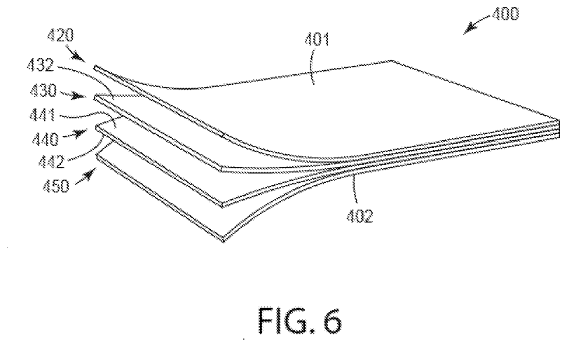

In a second exemplary embodiment as shown in FIG. 6, thermal barrier composite material 400 has a front side 401 and a back side 402. Thermal barrier composite material 400 has a porous core layer 440 having first and second major surfaces 441, 442, respectively. A radiant barrier 430 can be disposed on the first major surface of the porous core layer and a first flame barrier layer 420 disposed on a second surface 432 of the radiant barrier layer opposite porous core layer 440. In some exemplary embodiments, thermal barrier composite material 400 can further include a second flame barrier layer 450 disposed on the second major surface 442 of porous core layer 440. In some aspects of the invention, porous core layer 440 can be a thermally expandable layer. In some aspects of the invention, the first and/or the second flame barrier layers 420, 450 can be formed of electrically insulating materials. In general, thermal barrier composite materials described in the present disclosure should have a thickness less than or equal to 5 mm with some exemplary thermal barrier composite materials described in the present disclosure should have a thickness less than or equal to 4 mm, depending on the application where the material will be used.

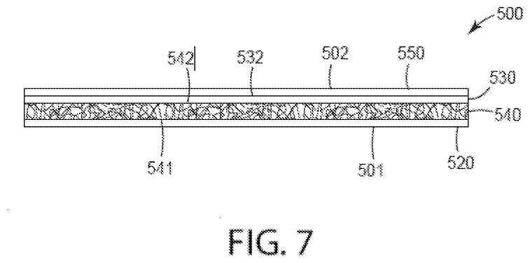

A third alternative exemplary thermal barrier composite material 500 is shown in FIG. 7. Thermal barrier composite material 500 has a front side 501 and a back side 502. Thermal barrier composite material 500 includes a porous core layer 540 having first and second major surfaces 541, 542, respectively. A first flame barrier layer 520 is disposed on the first major surface 541 of the porous core layer 540, and radiant barrier 530 can be disposed on the second major surface 542 of the porous core layer. A second flame barrier layer 520 disposed on a second surface 532 of the radiant barrier layer opposite porous core layer 540. In some aspects of the invention, porous core layer 540 can be a thermally expandable layer. In an exemplary aspect, the first and/or the second flame barrier layers 520, 550 can be formed of electrically insulating materials.

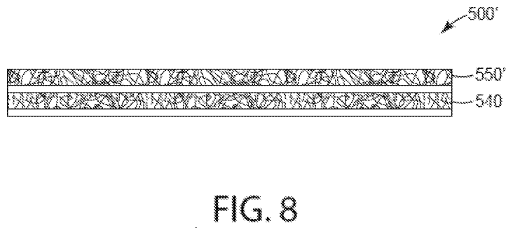

FIG. 8 illustrates another exemplary thermal barrier composite material 500′ which is substantially same as thermal barrier composite material 500, shown in FIG. 7, except that the second flame barrier layer 550′ is a porous layer.

In some embodiments, porous core layer 52, 440, 540 and second flame barrier layer 550′ can be an engineered nonwoven material, fabric or felt, or it can be a volume compliant material such as a closed cell foam sheet or open cell foam sheet. In some exemplary embodiments, the porous core layer may be a composite structure of a nonwoven material and a volume compliant material. In one exemplary aspect, the porous core layer can further comprise a polymeric film disposed as a skin layer on either one or both surfaces of the nonwoven or volume compliant material. In an alternative aspect, the porous core layer can comprise a polymeric film layer disposed between two layers of ether a nonwoven material, a volume compliant material or a combination thereof.

In some aspects of exemplary thermal barrier material, the porous core layer is a nonwoven mat. In other aspects of exemplary thermal barrier material, the porous core layer is a nonwoven fabric, while in yet other aspects of exemplary thermal barrier material, the porous core layer is a nonwoven felt.

The presence of air in a porous thermally expandable layer can improve the thermal insulating properties of the exemplary composite material. Suitable nonwoven materials may be formed through any suitable method, and with any suitable material. For example, the non-woven can be (e.g., lofty, carded, air-laid, or mechanically bonded, such as spun-lace, needle-entangled, or needle-tacked), woven, knitted, mesh, or perforated film. The fibrous web or sheet can be bonded (e.g., the fibers are bonded to one another at various locations) or non-bonded.

Exemplary nonwoven materials suitable for use in the present invention can be glass fiber nonwoven materials such as fiber glass mats available from BFG Industries, ceramic fiber insulation materials, silicate fiber insulation materials such as available under the tradename TREO® from McAllister Mills, Inc. (Independence, Va.), or organic nonwoven materials comprising polyacrylamide fibers, flame retardant polyester fibers (PET-FR), oxidized polyacrylonitrile (OPAN) fibers, or combinations thereof. For example, exemplary OPAN/PET-FR nonwoven materials are described in PCT Application No. PCT/CN2017/110372, herein incorporated by reference in its entirety.

In some aspects of exemplary thermal barrier material, the nonwoven material is a glass fiber nonwoven material. In other aspects of exemplary thermal barrier material, the nonwoven material is a silicate fiber insulation, while in yet other aspects of exemplary thermal barrier material, the nonwoven material is an organic nonwoven material.

Exemplary materials for the polymeric film layer are thermally stable polymer films such as a polytetrafluoroethylene (PTFE) film, a polyimide (PI) film, polyethylene-naphthalate (PEN) film, polyetherimide films and the like. Exemplary porous core layer materials should have a thickness of 3 mm or less.

In some aspects of thermal barrier composite material 50, 400, 500, 500′, porous core layer 52, 440, 540 can be a thermally expandable layer comprising a nonwoven or woven mat of any of the materials described previously that have been embedded with an thermally expandable substance dispersed therein. The nonwoven webs described above can further include a coating, an organic or inorganic binder, a flame retardant, fibers, glass microfibers, aramid fibers, an intumescent material (e.g., a fiber or a particle), mica, graphite particles, clay, vermiculite particles, glass bubbles, carbon particles, or a combination thereof.

The thermally expandable substance can be an endothermic material or an intumescent material that expands when the thermal barrier composite material is exposed to high heat (e.g. 800-1200° C.) during a cell/module failure. In general, the thermally expandable substance can absorb heat to fuel a chemical reaction that results in internal pressure within a thermally expandable substance which causes the substance to expand which in turn results in the expansion expandable core layer further enhancing the thermal insulating performance of the core layer.

Useful intumescent materials for use in the thermal barrier composites described herein may include, but are not limited to, unexpanded vermiculite ore, treated unexpanded vermiculite ore, partially dehydrated vermiculite ore, expandable graphite for example, under the trade designation “GRAFOIL GRADE 338-5O” from UCAR Carbon Co., Inc. (Cleveland, Ohio), mixtures of expandable graphite with treated or untreated unexpanded vermiculite ore, processed expandable sodium silicate, for example EXPANTROL™ insoluble sodium silicate, commercially available from 3M Company, St. Paul, Minn., USA, and mixtures thereof.

The selection of intumescent particles may vary depending, for example, on the desired end use. For example, for temperatures about 500° C., unexpanded vermiculite materials are desirable because they typically start to expand at a temperature in a range from about 300 to about 340° C. For use temperature below about 500° C., expandable graphite or a mixture of expandable graphite and unexpanded vermiculite materials may be desired since expandable graphite typically starts to expand or intumesce at about 510° C. Treated vermiculites are also useful and typically expand at a temperature of about 590° C.

In some embodiments, the intumescent particles have a layered structure that allows for easy exfoliation. Within the individual layers of the particle, fluids (e.g., sulfuric acid) may be introduced and held tightly to the surface of the layer (intercalated). When such material is exposed to heat the fluid held within the layers expands. The expansion of the fluid pushes against the individual layer, separating them apart (exfoliation). An observed result of this behavior is that the volume occupied by the thermally expandable layer expanding increases. The degree of expansion, and the temperature at which expansion takes place, is dependent, for example, on the type of fluid intercalated into the layers. Typically, the thermally expandable layer can have an expansion factor in the range of 5-3 times (i.e. when comparing the initial thickness of the expandable core layer to the thickness after expandable core layer after exposure to high heat). Thermally expandable layer 440 can be a glass, ceramic, or other flame resistant fiber-based mat or felt with expandable particles such as vermiculite or expandable graphite dispersed though out the fiber matrix. In one exemplary aspect, the thermally expandable layer can be a ceramic mat comprising vermiculite dispersed within the mat, such as 3M™ Interam Mat I-10 available from 3M Company (St. Paul, Minn., USA).

In some aspects of exemplary thermal barrier material, the flame retardant/barrier layers can comprise inorganic paper materials. In other aspects of exemplary thermal barrier material, the flame retardant/barrier layers can comprise mica-based materials. Exemplary flame retardant layers 54, 55 can comprise inorganic paper materials such as 3M Flame Barrier White FRB-WT145 or 3M™ CeQUIN Inorganic Insulating Paper available from 3M Company (St. Paul Minn.), and mica-based materials such as mica foils and mica sheets are available from Cogebi, Inc. (Dover, N.H.) and others. As mentioned earlier, one or more of the flame retardant/barrier layers can be a porous layer that comprise materials similar to the porous core layer, as described above. Exemplary flame barrier layers can have a thickness between 0.05 mm and 2.5 mm with the inorganic papers having a thickness up to about 0.5 mm and the mica based materials having thicknesses typically in the range of 0.05-1 mm thickness. When porous materials are used, the flame retardant/barrier layer can have thicknesses up to about 2.5 mm.

In some applications, the exemplary thermal barrier composite material can be used such that the potential fire source is located in a known orientation with respect to the thermal barrier composite material (e.g. on the front side 401, 501 of thermal barrier composite material 400, 500, respectively). In this case the second flame barrier layer 450, 550 can be composed of fire resistant, electrical insulating layer. Exemplary fire resistant, electrical insulating layers can comprise a polyimide tape; a mica paper, sheet or board; an inorganic paper or inorganic paper laminate; a silicone rubber or polytetrafluoroethylene coated fabric or nonwoven of fiberglass, basalt fibers, ceramic fibers or OPAN fibers; or a glass, ceramic or OPAN fiber-based nonwoven mat or felt.

The radiant barrier layer in the exemplary thermal barrier composite material can disperse the energy from a point or localized source to a wider area of the thermal barrier composite material to reduce the heat flux density (heat flow per unit area) that can occur during a cell or module failure. When the thermal barrier composite material is exposed to a flame/heat, the radiant barrier layer works with the thermally expandable layer to reduce the average temperature on the side of the thermal barrier composite material opposite the flame/heat source.

Radiant barrier layer can also enhance the flexibility and strength of the thermal barrier composite material. In some aspects of exemplary thermal barrier material, the at least one radiant barrier layer can be a metal foil, sheet or plate made, for example, of aluminum, copper, iron, or stainless steel. In other aspects of exemplary thermal barrier material, the at least one radiant barrier layer can be a metal foil tape. Exemplary radiant barrier layers 56, 57, 430, 530 can comprise metal foils as aluminum foil, copper foil or metal foil tapes such as 3M™ Aluminum Foil Shielding Tape 1170 3M company (St. Paul, Minn.). Other exemplary materials may include metal shim stock or metal clad polymer composites. In one exemplary aspect, the radiant barrier layer can be stainless-steel foil sheet or plate with 0.01-0.1 mm thickness.

The exemplary composite materials described herein can be formed by combining functional layers (i.e. the porous core layer, the flame retardant layers and the radiant barrier layer(s) using conventional lamination techniques. In some embodiments, an adhesive may be used to bond adjacent layers together. In an alternative aspect the layers can be ultrasonically welded together. While in a third embodiment, one or more of the layers can include a bonding agent which allow the thermal bonding of the various layers to form the exemplary composite material.

Adhesives used to laminate the functional layers together can be acrylic-based adhesives, epoxy-based adhesives, or silicone-based adhesives. The adhesives can be insulating adhesives, thermally conductive adhesives, flame retardant adhesives, electrically conducting adhesives, or an adhesive having a combination of conductive and flame retardant properties.

The exemplary adhesives used in the lamination can be contact adhesives, pressure sensitive (PSA) adhesives, B-stageable adhesives or structural adhesives. In an exemplary aspect an acrylic PSA can be used to bond together the functional layers of the thermal barrier composite material. The adhesives can be directly coated onto one of the functional layers and optionally dried or can be preformed into freestanding lamination film adhesives that can be applied to the surface of one of the functional layers prior to contacting the next functional layers. In an alternative aspect, one or more of the functional layers can be in the form of a tape having an adhesive layer (e.g. a pressure sensitive adhesive layer) already disposed on the functional material.

The purpose and use of the exemplary composite materials in the battery packs of electric vehicles drives the physical, electrical and thermal properties of composite material. In general, the exemplary composite materials should be thin, compressible, electrically insulating and thermally stable. For example, thickness of the exemplary composite materials should be between 0.5 mm and 5 mm, preferably between 1 and 3 mm.

The exemplary composite materials should have an elastic compressibility between about 1 psi and about 10 psi, preferably between about 1 psi and about 5 psi, when compressed to a thickness of 2 mm. In an alternative aspect, the exemplary composite materials should have an elastic compressibility less than 10 psi, preferably less than 5 psi, when compressed to a thickness of 2 mm.

As mentioned previously, the exemplary flame barrier composite materials can be used as a protective device or system, such as a thermal/flame barrier. For example, one or more sheets of an exemplary electrical insulating material can be incorporated into or wrapped around a flammable energy storage device, such as lithium ion battery cells, modules, or packs, such as may be found in hybrid or electric vehicles or other electric transportation applications or locations. In other applications, the exemplary flame barrier composite materials can be used as a lid/pack liner for said flammable energy storage devices. The exemplary thermal barrier material of the present invention should prevent heat from flowing from a failing cell or module to an adjacent cell or module or the passenger compartment. For example, the exemplary thermal barrier materials should provide a high thermal gradient or temperature drop across the material when exposed to high temperature on one side of the material. In an alternative, the exemplary material may be used as a thermal barrier wrap or as a thermal barrier lid in an electric vehicle battery pack that can prevent or reduce the rate of heat flow out of the battery pack. The thermal barrier performance of the exemplary thermal barrier composite materials described herein can be evaluated by subjecting a first surface of the composite material to a high side temperature, T₁, and measuring the temperature of the opposing surface of the module or low side temperature, T₂, after a prescribed exposure to the elevated temperature. T₂ should be significantly lower than T₁. The passing criteria for thermal barrier performance can be when the low side temperature, T₂, is beneath a particular numerical limit or may be represented as a function of high side temperature T₁. For example, a composite material can be said to have adequate thermal performance when low side temperature T₂ is less than or equal to 140° C., preferably less than or equal to 120° C., when T₁ is 600° C. Alternatively, a composite material can be said to have adequate thermal performance when T₂ is less than or equal 25% of the high side temperature (i.e. T₂≤0.25*T₁), preferably less than or equal 20% of the high side temperature (i.e. T₂≤0.20*T₁).

In an alternative aspect, a composite material can be said to have adequate thermal performance when low side temperature T₂ should be about 350° C. or less, preferably about 300° C., when T₁ is 1000° C. Alternatively, a composite material can be said to have adequate thermal performance when T₂ is less than or equal 33% of the high side temperature (i.e. T₂≤0.33*T₁) when T₁ is about 1000° C.

Because low thermal transfer through the thermal barrier material is desired, the exemplary thermal barrier composite materials of the present invention should have a z-axis thermal conductivity of less than 0.25 W/m-K, preferably less than 0.20 W/m-K, most preferably less than 0.15 W/m-K.

In some applications, the exemplary composite material may be used as a protective wrap in which case the exemplary composite material should be able to bend around the edges of the item being wrapped without cracking or degradation to the other properties of the material.

Depending on the application, the exemplary composite material can have any combination of thermal conductivity, elastic compressibility, thickness, and thermal barrier performance that fall within the ranges provided above.

As mentioned previously, the exemplary composite materials can be used in a protective device or system, such as a thermal/flame barrier. For example, one or more sheets of an exemplary electrical insulating material can be incorporated into or wrapped around a flammable energy storage device, such as lithium ion battery cells, modules, or packs, such as may be found in hybrid or electric vehicles or other electric transportation applications or locations.

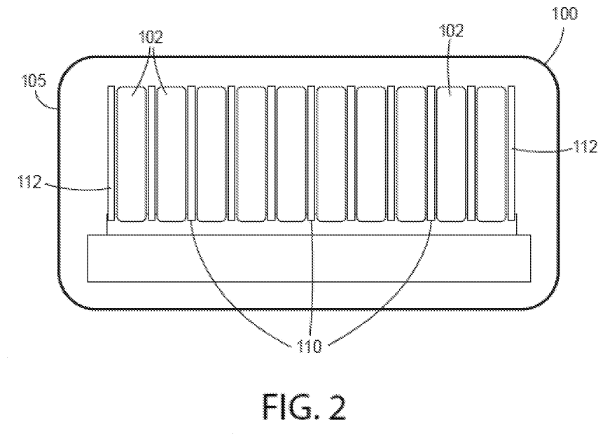

FIG. 2 shows an exemplary battery module 100 comprising a plurality of battery cells 102 disposed in a housing 105. The exemplary thermal barrier composite material can be used as an insert 110 between adjacent battery cells 102 to prevent or slow a thermal runaway event from spreading to other battery cells in a given battery module and an outer wrap 112 that is disposed round the circumference of the cells in a battery module to prevent or slow a thermal runaway event from spreading to an adjacent battery module for the module according to an aspect of the invention. The inserts 110 between the battery cells can be in the form of sheets or boards positioned between adjacent cells, a flexible wrap surrounding the circumference of the cell, or a length of composite material that is serpentine back and forth and around the cells.

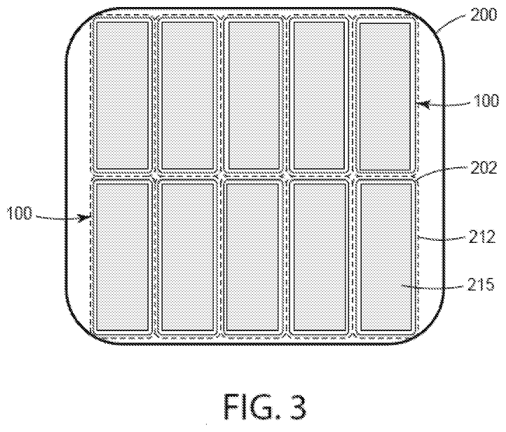

FIG. 3 shows a top view of an exemplary battery pack 200 having a plurality of battery modules 100 that includes a thermal barrier comprising thermal barrier composite material disposed as an outer wrap 212 around each of the plurality of modules and as a thermal barrier cover 215 disposed on top of each module according to an aspect of the invention. Thus, the exemplary composite material can be used as a series of thermal barrier/flame resistant encasement liners to encase one or more of the lithium ion battery modules 202. Alternatively, one or more sides of the lithium ion battery pack 200 itself can be wrapped, covered or lined with a thermal barrier/flame resistant encasement liner.

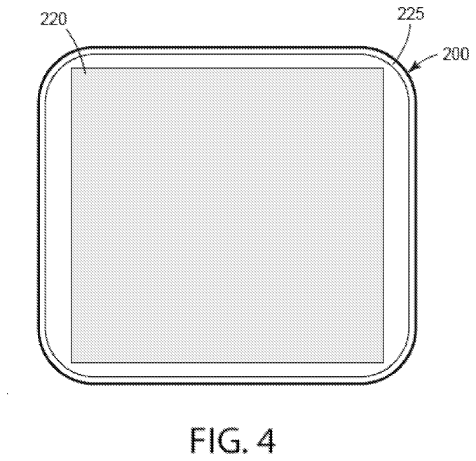

FIG. 4 shows exemplary battery pack 200 that has a supplemental wrap 225 around the circumference of all the modules in the battery pack and as a thermal barrier cover 220 extending over a plurality of battery modules (not shown) in the battery pack comprising thermal barrier composite material disposed over all the modules in the battery pack according to an aspect of the invention.

### LISTING OF EMBODIMENTS

Following are some illustrative embodiments of exemplary thermal barrier composite materials described herein.

### Embodiment 1

A thermal barrier composite material comprises a porous core layer; a pair of flame retardant layers disposed on either side of the porous core layer; and at least one radiant barrier layer disposed between the porous core layer and one of the pair of flame retardant layers.

### Embodiment 2

The composite material of Embodiment 1, wherein the composite material comprises a first radiant barrier layer adjacent to a first major surface of the porous core layer and a first flame retardant layer disposed on a surface of the first barrier layer opposite the porous core layer and a second radiant barrier layer disposed adjacent to a second major surface of the porous core layer and a second flame retardant layer disposed on a surface of the second barrier layer opposite the porous core layer.

### Embodiment 3

The composite material of Embodiment 1 or Embodiment 2, wherein the porous core layer is a nonwoven material selected from a nonwoven mat, a nonwoven fabric or a nonwoven felt. In some aspects of embodiment 3, the porous core layer is a nonwoven mat. In other aspects of embodiment 3, the porous core layer is a nonwoven fabric, while in yet other aspects of embodiment 3, the porous core layer is a nonwoven felt.

### Embodiment 4

The composite material of Embodiment 1 or Embodiment 2, wherein the porous core layer is a volume compliant material selected from a closed cell foam sheet and an open cell foam sheet. In some aspects of embodiment 4, the volume compliant material is a closed cell foam sheet. In other aspects of embodiment 4, the volume compliant material is an open cell foam sheet.

### Embodiment 5

The composite material of Embodiment 3, wherein the nonwoven material is one of a glass fiber nonwoven material, a silicate fiber insulation, or an organic nonwoven material. In some aspects of embodiment 5, the nonwoven material is a glass fiber nonwoven material. In other aspects of embodiment 5, the nonwoven material is a silicate fiber insulation, while in yet other aspects of embodiment 5, the nonwoven material is an organic nonwoven material.

### Embodiment 6

The composite material of Embodiment 5, wherein the organic nonwoven materials comprise polyacrylamide fibers, flame retardant polyester fibers, oxidized polyacrylonitrile fibers, or combinations thereof. In some aspects of Embodiment 6, the organic nonwoven materials comprise polyacrylamide fibers. In other aspects of Embodiment 6, the organic nonwoven materials comprise flame retardant polyester fibers. In yet other aspects of Embodiment 6, the organic nonwoven materials comprise oxidized polyacrylonitrile fibers.

### Embodiment 7

The composite material of any of the previous Embodiments, wherein the flame retardant layers comprise inorganic paper materials or mica-based materials. In some aspects of embodiment 7, the flame retardant layers comprise inorganic paper materials. In some aspects of embodiment 7, wherein the flame retardant layers comprise mica-based materials.

### Embodiment 8

The composite material of any of the previous Embodiments, wherein the at least one radiant barrier layer comprises one of a metal foil and a metal foil tape. In some aspects of embodiment 8, the at least one radiant barrier layer is a metal foil. In other aspects of embodiment 8, at least one radiant barrier layer is a metal foil tape.

### Embodiment 9

The composite material of any of the previous Embodiments, further comprising an adhesive to bond one or more of the layers in the composite material together.

### Embodiment 10

The composite material of Embodiment 9, wherein the adhesive is one of an acrylic-based-adhesive, epoxy-based adhesive, and a silicone-based adhesive. In some aspects of embodiment 10, the adhesive is an acrylic-based adhesive. In other aspects of embodiment 10, the adhesive is an epoxy-based adhesive. In yet other aspects of embodiment 10, the adhesive is a silicone-based adhesive.

### Embodiment 11

The composite material of either of Embodiments 9 and 10, wherein the adhesive is an insulating adhesive, a thermally conductive adhesive, a flame retardant adhesive, an electrically conductive adhesive, or an adhesive having a combination of conductive and flame retardant properties.

### Embodiment 12

The composite material of any of Embodiments 9-11, wherein the adhesive is a pressure sensitive adhesive.

### Embodiment 13

The composite material of any of Embodiments 9-12, wherein the adhesive is laminating film adhesive.

### Embodiment 14

The composite material of any of the previous Embodiments, wherein the composite material has a thickness of between 0.5 mm and 5 mm, preferably between 1 mm and 3 mm. In some aspects of embodiment 14, the composite material has a thickness of between 0.5 mm and 5 mm, while in other aspects of embodiment 14, the composite material has a thickness of between 1 mm and 3 mm.

### Embodiment 15

The composite material of any of the previous Embodiments, wherein the composite material has an elastic compressibility less than 10 psi, preferably less than 5 psi, when compressed to a thickness of 2 mm. In some aspects of embodiment 15, the composite material has an elastic compressibility less than 10 psi when compressed to a thickness of 2 mm, while in other aspects of embodiment 15, the composite material has an elastic compressibility of less than 5 psi when compressed to a thickness of 2 mm.

### Embodiment 16

The composite material of any of the previous Embodiments, wherein the composite material has an elastic compressibility between about 1 psi and about 10 psi, preferably between about 1 psi and about 5 psi, when compressed to a thickness of 2 mm. In some aspects of embodiment 16, the composite material has an elastic compressibility between about 1 psi and about 10 psi when compressed to a thickness of 2 mm, while in other aspects of embodiment 16, the composite material has an elastic compressibility between about 1 psi and about 5 psi when compressed to a thickness of 2 mm.

### Embodiment 17

The composite material of any of the previous Embodiments, wherein the composite material has a low side temperature of less than or equal to 140° C., preferably less than or equal to 120° C., when a high side temperature is 600° C. In some aspects of embodiment 17, the composite material has a low side temperature of less than or equal to 140° C. when a high side temperature is 600° C. In alternative aspects, of embodiment 17, the composite material has a low side temperature of less than or equal to 120° C. when a high side temperature is 600° C.

### Embodiment 18

The composite material of any of the previous Embodiments, wherein the composite material has a low side temperature, T2, is less than or equal to 25% of the high side temperature, T1, preferably less than or equal to 20% of the high side temperature. In some aspects of embodiment 18, the composite material has a low side temperature, T2, is less than or equal to 25% of the high side temperature, T1. In other aspects of embodiment 18, the composite material has a low side temperature, T2, is less than or equal to 20% of the high side temperature, T1.

### Embodiment 19

The composite material of any of the previous Embodiments, wherein the composite material has a z-axis thermal conductivity of less than 0.25 W/m-K, preferably less than 0.20 W/m-K, most preferably less than 0.15 W/m-K. In some aspects of embodiment 19, the composite material has a z-axis thermal conductivity of less than 0.25 W/m-K. In other aspects of embodiment 19, the composite material has a z-axis thermal conductivity of less than 0.20 W/m-K, while in yet other aspects of embodiment 19, the composite material has a z-axis thermal conductivity of less than 0.15 W/m-K.

### Embodiment 20

The composite material comprises any combination of properties provided by Embodiments 14-19.

### Embodiment 21

A protective device, comprising the composite of any of the preceding Embodiments incorporated as part of a lithium ion battery cell, module or pack.

### Embodiment 22

The composite material of any of the previous Embodiments, wherein the porous core layer is a thermally expandable layer having first and second major surfaces.

### Embodiment 23

A thermal barrier composite material comprises a porous core layer that is a thermally expandable layer having first and second major surfaces; a radiant barrier layer disposed on the first major surface of the thermally expandable layer; and a flame barrier layer disposed on a second surface of the radiant barrier layer opposite the thermally expandable layer. In some embodiments, the thermal barrier composite may further comprise a second flame barrier layer disposed on the second major surface of the thermally expandable layer.

### Embodiment 24

A thermal barrier composite material comprises a porous core layer, wherein the porous core layer is a thermally expandable layer having first and second major surfaces, a first flame barrier layer disposed on the first major surface of the thermally expandable layer, a radiant layer disposed on a second major surface of the thermally expandable layer and a second layer flame barrier layer disposed on the radiant layer opposite the thermally expandable layer.

### Embodiment 25

The thermal barrier composite material of Embodiments 22-24, wherein the thermally expandable layer comprises a porous material comprises a woven or nonwoven mat material having an expandable substance dispersed therein.

### Embodiment 26

The thermal barrier composite material of Embodiment 24, wherein the expandable substance is vermiculite. In an alternative embodiment, the expandable substance is expandable graphite.

### Embodiment 27

The thermal barrier composite material of Embodiments 23-26, wherein the radiant barrier is a metal foil or sheet. In some embodiments of the thermal barrier composite the radiant barrier is a stainless steel foil, aluminum foil or a copper foil.

### Embodiment 28

The thermal barrier composite material of Embodiments 23-27, wherein the first flame retardant layer is a mica tape or sheet material. In some embodiments of the thermal barrier composite material, the first flame retardant layer is formed from an inorganic paper.

### Embodiment 29

The thermal barrier composite material of Embodiments 23-28, wherein the second flame retardant layer is selected from a mica tape, an inorganic paper, a ceramic mat, polyamide tape and a coated fiberglass woven mat. In some embodiments of the thermal barrier composite material, the second flame retardant layer is formed from an inorganic paper. In other embodiments of the thermal barrier composite material, the second flame retardant layer is a ceramic mat. In still other embodiments of the thermal barrier composite material, the second flame retardant layer is a polyamide tape and in yet other embodiments of the thermal barrier composite material, the second flame retardant layer is a silicone coated fiberglass woven mat.

### Embodiment 30

The thermal barrier composite material of Embodiments 23-29, wherein the thermally expandable layer has an expansion factor of at least 2.

Of course, these examples are just a few of many types of implementations for the thermal barrier composite materials described herein, as would be apparent to one of ordinary skill in the art given the present description. Those of ordinary skill in the art will recognize that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims.

### Examples

These examples are for illustrative purposes only and are not meant to be limiting on the scope of the appended claims. All parts, percentages, ratios, etc. in the examples and the rest of the specification are by weight, unless otherwise noted.

Test Methods

| | Test Method |
|---|---|
| Thickness | ASTM D645 - Standard Test Method for Thickness of |
| | Paper and Paperboard |
| Basis Weight | ASTM D202 - Standard Test Method for Sampling |
| | and Testing Untreated Paper Used for Electrical |
| | Insulation |
| Bulk Resistivity | ASTM D257 - Standard Test Methods for |
| | DC Resistance or Conductance of Insulating Materials |
| Thermal | ASTM D-5470 - Standard Test Method for Thermal |
| Conductivity | Transmission Properties of Thermally Conductive |
| | Electrical Insulation Materials |

Heat Flow Resistance Test

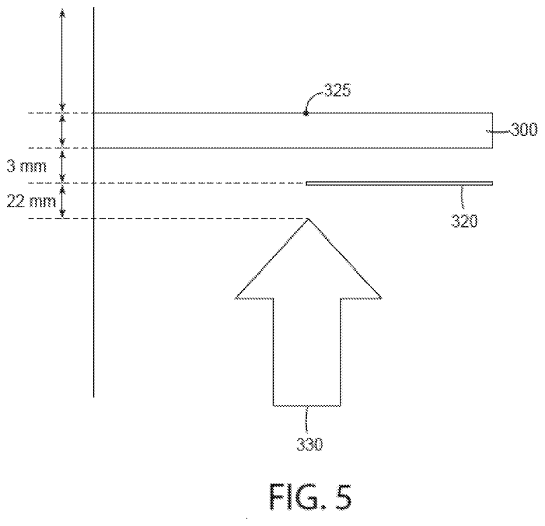

FIG. 5 is a schematic diagram of the heat flow resistance test. The test specimen 300 was placed on a ring style holder (not shown). A thermocouple rod was placed 3 mm below the sample to measure the test temperature, T₁, on the first side of the sample from a heat source 330 placed 25 mm below the sample. The heat source was a Model HG 2520 E heat gun available from Steinel with the output set to 704° C. The test temperature was 600° C. The air flow of the heat gun was set on 3 out of 10. A set of three thermocouples 325 were placed on the surface of the test specimen opposite the focal point of the heat source to measure the low side temperature, T₂. The test specimen is exposed to the heat source for 11 minutes and the maximum low side temperature, T₂ is measured.

In an alternative heat flow test, a test specimen is clamped to a frame. A thermocouple was placed on the front side of the sample to measure the test temperature, T₁, and a second thermocouple was placed on the second side of the sample to measure the low side temperature, T₂. A flame from a butane torch was positioned so that the inner flame contacted the front side of the test specimen so that T₁=4000° C. The test specimen is exposed to the heat source for 40 minutes and the maximum low side temperature, T₂, was measured.

Compression Test

The sample to be tested was placed on a stationary platen affixed to a Instron Universal Test System, Model 5967, available from Instron (Norwood, Mass.) equipped with a 30 kN load cell. A mobile platen is moved toward the stationary platen at a crosshead speed of 2 mm/min. The maximum force is recorded when the platens are 2 mm apart.

The property data for exemplary flame barrier materials is presented in Table 3 and the property data for the comparative materials is presented in Table 4.

Materials

Core Layer Materials

| | |
|---|---|
| glass fiber | 4008 TECHMAT^{®} 1200° F. - high temp. |
| nonwoven | thermal insulation, available from |
| | BFG Industries (Greensboro, NC) |
| OPAN/PET | 80% OPAN staple fibers (1.7 dtex × 50 mm length) |
| | available under the Trade name Zoltek OX Staple |
| | fibers from Zoltek (Bridgeton, MO) and 20% PET- |
| | FR Staple fibers Trevira T270 (6.7dtex × 60 mm? |
| | length) T270 flame retardant polyester fiber nonwoven |
| | material prepared as describes in PCT |
| | Application No. CN2017/110372 |
| Silicate fiber | TREO® Ceramic Free Needled Mat, available from |
| nonwoven | McAllister Mills, Inc. (Independence, VA) |
| PTFE tape | 3M 60 PTFE Electrical Tape (PTFE backing |
| | with a silicone adhesive), available |
| | from 3M Company (St. Paul, MN) |
| Expandable | 1.5 mm - 3M™ Interam™ Mat I-10 ceramic fiber |
| Ceramic Mat | nonwoven that expands in thickness to provide |
| | low-density insulation when |
| | exposed to high temperatures or flames, available |
| | from 3M Company (St. Paul, MN USA) |

Flame Retardant/Barrier Layer Materials

| | |
|---|---|
| Inorganic | 3M Flame Barrier White FRB-WT145, available |
| paper | from 3M Company (St. Paul, MN) |
| Combi 504 | Coge-combi 504 flexible mica foils (504-48-2), |
| | available from Cogebi, Inc. (Dover, NH) |
| 132 P Mica | 0.032 in. (0.81 mm) thick Flexible Cogemicanite |
| sheet | 132-1P Phlogopite Flexible Mica Sheet, |
| | available from Cogebi, Inc. (Dover, NH) |
| Mica Sheet B | 0.15 mm Mica Sheet, available from Weipai Mica |
| | Insulation Material Company (China) |
| Polyimide | 0.03 mm 3M™ Polyimide Film Electrical Tape |
| Tape | 92 from 3M Company |
| | available from 3M Company (China) |
| Expandable | 2.4 mm 3M™ Interam™ Mat - Nonwoven |
| Ceramic Mat | mat made from inorganic alkaline earth |
| | silicate fibers, available from 3M Company |
| | available from 3M Company (St. Paul, MN USA) |
| Inorganic | 0.055 mm 3M™ CeQUIN Inorganic Insulating Paper, |
| Paper | available from 3M Company (St. Paul, MN USA) |
| silicone coated | 0.8 mm, silicone coated fiberglass fire resistance |
| fiberglass | cloth, available from Dexing Fire-Resistant |
| woven | Materials Factory (China) |
| ceramic e-mat | 2.4 mm 3M™ Interam™ Endothermic Mat, available |
| | from 3M Company (St. Paul, MN USA) |

Barrier Layer Materials

| | |
|---|---|
| SS foil | 0.05 mm - Stainless Steel Foil |
| Al foil | 0.05 mm Aluminum foil (2 mil) |
| Cu foil | 0.036 mm Copper foil (1.4 mil) |
| Cu sheet | 0.2 mm Copper foil (7.9 mil) |
| 1170 tape | 3M™ Aluminum Foil Shielding Tape 1170 (2.0 |
| | mil aluminum with an acrylic adhesive), |
| | available from 3M Company (St. Paul, MN) |
| 1115B Tape | 3M™ Aluminum Foil Tape 1115B (4.5 mil |
| | aluminum with a conductive acrylic adhesive), |
| | available from 3M Company (St. Paul, MN) |

Adhesive Materials

| | |
|---|---|
| Acrylic PSA | 3M™ High Performance Acrylic Adhesive 200MP (467MP), |
| sheet | available from 3M Company (St. Paul, MN) |

In general, the examples were laminated by hand, layer by layer from the outside in for most cases. When one of the layers was a tape, the sticky side was applied to the outer layer, unless otherwise noted below.

### Examples 1 and 2

A composite sheet of thermal barrier material was made by first applying a layer of 1170 tape onto the surface of two pieces of FRB inorganic paper. A hand-held rubber roller was used to apply light pressure assuring that the 1170 tape was bonded to the FRB inorganic paper forming the outer layers of the composite sheet. An acrylic PSA sheet was applied to the aluminum backing side of the 1170 tape of both outer layers. A porous core layer was applied onto the adhesive coated surface of one of the adhesive coated outer layers and the second adhesive coated outer layer was placed adhesive side down on top of the porous core layer. The roller was again used to apply light pressure assuring that all layers of the composite sheet were bonded together. A summary of the layer structure of examples 1 and 2 is provided in Table 1 and property data for examples 1 and 2 is provided in Table 3.

### Examples 3 and 4

A composite sheet of thermal barrier material was made by first applying an acrylic PSA sheet onto a surface of two pieces of FRB inorganic paper. A metal foil layer was applied onto the adhesive surface of each of the pieces of adhesive coated FRB inorganic paper. A hand-held rubber roller was used to apply light pressure assuring that the metal foil was bonded to the FRB inorganic paper forming the outer layers of the composite sheet. Another layer of acrylic PSA sheet was applied to the exposed metal surface of both outer layers. A porous core layer was applied onto the adhesive coated surface of one of the adhesive coated outer layers and the second adhesive coated outer layer was placed adhesive side down on top of the porous core layer. The roller was used again to apply light pressure assuring that all layers of the composite sheet were bonded together. A summary of the layer structure of examples 3 and 4 is provided in Table 1 and property data for examples 3 and 4 is provided in Table 3.

### Example 5

A composite sheet of thermal barrier material was made by first applying a layer of 1115B tape onto the surface of a first piece FRB inorganic paper. A hand held rubber roller was used to apply light pressure assuring that the 1115B tape was bonded to the FRB inorganic paper forming a first outer layer of the composite sheet. An acrylic PSA sheet was applied onto a surface of a second of FRB inorganic paper and set aside to serve as the second outer layer of the composite sheet. An acrylic PSA sheet was applied to the aluminum backing side of the 1115B tape of the first outer layer. A porous core layer was applied onto the adhesive coated surface of the first outer layers and the adhesive coated second outer layer was placed adhesive side down on top of the porous core layer. The roller was used again to apply light pressure assuring that all layers of the composite sheet were bonded together. A summary of the layer structure of example 5 is provided in Table 1 and property data for example 5 is provided in Table 3.

### Example 6

A surface of two pieces of FRB inorganic paper were coated with 400 nm of aluminum by a conventional vacuum vapor deposition process. An acrylic PSA sheet was applied to the exposed aluminum surface of both pieces of metalized FRB inorganic paper. A porous core layer was applied onto the adhesive coated surface of one of pieces of metalized FRB inorganic paper and the second adhesive coated pieces of metalized FRB inorganic paper was placed adhesive side down on top of the porous core layer. A hand-held roller was used to apply light pressure assuring that all layers of the composite sheet were bonded together. A summary of the layer structure of example 6 is provided in Table 1 and property data for example 6 is provided in Table 3.

### Example 7

The porous core layer for example 7 was created by applying a layer of PTFE tape on each side of a silicate fiber nonwoven. A hand held roller was used to apply light pressure to assure that the PTFE layers were bonded to the silicate fiber nonwoven. A composite sheet of thermal barrier material was made using this PTFE lined silicate fiber nonwoven as the porous nonwoven layer using the method outline above for Examples 1 and 2. A summary of the layer structure of example 7 is provided in Table 1 and property data for example 7 is provided in Table 3.

### Example 8

A sheet of a thermal barrier composite material was made by first applying an acrylic PSA sheet to a surface of a 0.15 mm thick mica sheet B (first flame barrier layer). Next a 4.5 mm thick sheet of an Expandable Ceramic Mat was placed on the acrylic adhesive PSA layer. A hand-held rubber roller was used to apply light pressure to the surface of the Expandable Ceramic Mat assuring that the mica sheet B was bonded to the Expandable Ceramic Mat. Next a second acrylic PSA sheet was placed on the surface of the Expandable Ceramic Mat, and the Al foil was laminated onto the surface of the PSA sheet by hand-held rubber roller. Finally, another acrylic PSA sheet was placed on the surface of Al foil. A second mica sheet B was laminated on the surface of the PSA sheet, to yield the exemplary thermal barrier composite material (denoted Ex. 4 in tables 4 and 5).

### Examples 9-11

Examples 9-11 were prepared following the same general procedure as outlined in example 8. A summary of the layer construction for examples 8-17 is provided in Table 5 and Table 6 provides measured properties of the exemplary composite materials of examples 8-17.

### Comparative Examples

C1* was created by stacking together fourteen layers of FRB inorganic paper. Note the entry in Table 2 only presents 5 of the 14 layers for space.

C2 was created by stacking together two sheets of Mica (132P).

C3 was created by stacking 132P mica sheet and the Combi 504 material, both of which are available from Cogebi, Inc., with the insulation layer of the Combi 504 material on the inside of the stack.

C4 was prepared by first applying 1170 tape to 132P mica sheet and then stacking with the Combi 504 material on top of the aluminum tape layer.

C5 comprised a 2.0 mm mica board from Weipai mica Insulation Material Company (China), which is currently used for thermal barrier protection in battery packs and modules in electric and hybrid electric vehicles.

A summary of the layer structure of comparative examples C1-C4 are provided in Table 2 and property data for comparative examples C1-C4 is provided in Table 4.

TABLE 1
Summary of the layer structure of exemplary thermal barrier composite
materials (Examples 1-7)

| | 1^{st} Flame | | | | 2^{nd} Flame | |
|---|---|---|---|---|---|---|
| | retardant | 1^{st} Radiant | Porous Core | 2^{nd} Radiant | retardant | |
| Ex. | Layer | Layer | Layer | Layer | Layer | Adhesive |
| 1 | Inorganic | 1170 Tape | glass fiber | 1170 Tape | Inorganic | Acrylic PSA |
| | paper | | nonwoven | | paper | |
| 2 | Inorganic | 1170 Tape | OPAN/PET | 1170 Tape | Inorganic | Acrylic PSA |
| | paper | | | | paper | |
| 3 | Inorganic | Al foil | glass fiber | Al foil | Inorganic | Acrylic PSA |
| | paper | (2 mil Al) | nonwoven | (2 mil Al) | paper | |
| 4 | Inorganic | Cu foil | glass fiber | Cu foil | Inorganic | Acrylic PSA |
| | paper | (1.4 mil Cu) | nonwoven | (1.4 mil Cu) | paper | |
| 5 | Inorganic | 1115B Tape | glass fiber | | Inorganic | Conductive |
| | paper | (4.5 mil Al) | nonwoven | | paper | acrylic PSA/ |
| | | | | | | Acrylic PSA |
| 6 | Inorganic | Vapor coated | glass fiber | Vapor coated | Inorganic | Acrylic PSA |
| | paper | aluminum | nonwoven | aluminum | paper | |
| | | (400 nm Al) | | (400 nm Al) | | |
| 7 | Inorganic | 1170 Tape | PTFE lined | 1170 tape | Inorganic | Silicone |
| | paper | | silicate fiber | | paper | PSA/ |
| | | | nonwoven | | | Acrylic PSA |

TABLE 2
Summary of the layer structure of comparative examples

| Ex. | Layer 1 | Layer 2 | Layer 3 | Layer 4 | Layer 5 |
|---|---|---|---|---|---|
| C1* | Inorganic | Inorganic | Inorganic | Inorganic | Inorganic |
| | paper | paper | paper | paper | paper |
| C2 | Mica sheet | Mica sheet | | | |
| C3 | Mica sheet | Combi 504 | | | |
| C4 | Mica sheet | 1170 Tape | Combi 504 | | |

TABLE 3
Summary of the property data of exemplary thermal
barrier composite materials

| | Thermal | Basis | | | Bulk |
|---|---|---|---|---|---|
| | Barrier | Weight | Thickness | Compression | Resistivity |
| Ex. | (° C.) | (g/m²) | (mm) | (psi) | (ohm-cm) |
| 1 | 111 | 1092 | 3.2 | 3.25 | 1.065E+13 |
| 2 | 119 | 918 | 2.9 | 0.19 | 6.65E+13 |
| 3 | 144 | 1049 | 3.4 | 1.54 | 3.31E+13 |
| 4 | 301 | 1089 | 3.7 | 3.28 | 2.45E+13 |
| 5 | 158 | 1082 | 2.9 | 6.27 | 2.26E+13 |
| 6 | 203 | 1225 | 3.4 | 3.88 | 2.00E+13 |
| 7 | 153 | 1575 | 3.3 | 2.84 | 2.07E+13 |

TABLE 4
Summary of property data for comparative examples

| | Thermal | Basis | | | Bulk |
|---|---|---|---|---|---|
| | Barrier | Weight | Thickness | Compression | Resistivity |
| Ex. | (° C.) | (g/m²) | (mm) | (psi) | (ohm-cm) |
| C1 | 163 | 4078 | 2.9 | 207.80 | 2.09E+12 |
| C2 | 211 | 3952 | 2.3 | 8.11 | 2.03E+13 |
| C3 | 208 | 2779 | 3.7 | 17.70 | 1.01E+13 |
| C4 | 166 | 3047 | 3.7 | 16.36 | 2.20E+13 |

TABLE 5
Summary of the layer structure of exemplary thermal
barrier composite materials (Examples 8-17)

| | 1^{st} Flame | | Thermally | 2^{nd} Flame |
|---|---|---|---|---|
| Ex. | Barrier Layer | Radiant Layer | expandable layer | Barrier Layer |
| 8 | Mica sheet B | Al foil | Expandable | Mica sheet B |
| | | | Ceramic Mat | |
| 9 | Mica sheet B | Cu sheet | Expandable | Mica sheet B |
| | | | Ceramic Mat | |
| 10 | Mica sheet B | SS foil | Expandable | Mica sheet B |
| | | | Ceramic Mat | |
| 11 | Mica sheet B | SS foil | Expandable | Polyamide tape |
| | | | Ceramic Mat | |
| 12 | Mica sheet B | SS foil | Expandable | Silicone coated |
| | | | Ceramic Mat | fiberglass woven |
| 13 | Mica sheet B | SS foil | Expandable | Inorganic paper |
| | | | Ceramic Mat | |
| 14 | Mica sheet B | SS foil | Expandable | Ceramic e-mat |
| | | | Ceramic Mat | |
| 15 | Mica sheet B | SS foil | Expandable | Expandable |
| | | | Ceramic Mat | Ceramic Mat |
| 16 | Inorganic paper | SS foil | Expandable | Mica sheet B |
| | | | Ceramic Mat | |
| 17 | Inorganic paper | — | Expandable | Mica sheet B |
| | | | Ceramic Mat | |

Note:
Intervening adhesive layers are not shown in Table 5.

TABLE 6
Summary of the property data of exemplary thermal barrier composite
materials for Examples 8-17 and Comparative Example C5.

| | Basis | | High Side | Low Side |
|---|---|---|---|---|
| | Weight | Thickness | Temperature, T₁ | Temperature, T₂ |
| Ex. | (g/m²) | (mm) | (° C.) | (° C.) |
| 8 | 1465 | 1.94 | 1000 | 305 |
| 9 | 3110 | 2.09 | 1000 | 285 |
| 10 | 1730 | 1.94 | 1000 | 295 |
| 11 | 1573 | 1.82 | 1000 | 298 |
| 12 | 3030 | 2.59 | 1000 | 290 |
| 13 | 1629 | 1.85 | 1000 | 296 |
| 14 | 3330 | 4.00 | 1000 | 280 |
| 15 | 2880 | 4.00 | 1000 | 285 |
| 16 | 1629 | 1.85 | 1000 | 295 |
| 17 | 1195 | 1.77 | 1000 | 330 |
| C5 | 4150 | 2.00 | 1000 | >600 |

The thermal barrier composite material of Ex. 8-17 had a lower basis weight than the 0.2 mm mica sheet of comparative example C5. The exemplary thermal barrier composite materials also produced a higher thermal gradient between the front side and the backside of said thermal barrier composite materials.

Various modifications of the exemplary electrical insulating materials described herein including equivalent processes, as well as numerous structures to which the present invention may be applicable will be readily apparent to those of skill in the art to which the present invention is directed upon review of the present specification.

1. A thermal barrier composite material comprising
a porous core layer;
a pair of flame retardant layers disposed on either side of the porous core layer; and
at least one radiant barrier layer disposed between the porous core layer and one of the pair of flame retardant layers.

2. The composite material of claim 1, wherein the composite material comprises a first radiant barrier layer adjacent to a first major surface of the porous core layer and a first flame retardant layer disposed on a surface of the first radiant barrier layer opposite the porous core layer and a second radiant barrier layer disposed adjacent to a second major surface of the porous core layer and a second flame retardant layer disposed on a surface of the second radiant barrier layer opposite the porous core layer.

3. The composite material of claim 1, wherein the porous core layer is a nonwoven material selected from a nonwoven mat, a nonwoven fabric or a nonwoven felt and wherein the nonwoven material is one of a glass fiber nonwoven material, a silicate fiber insulation, or an organic nonwoven material.

4. The composite material of claim 1, wherein the porous core layer is a volume compliant material selected from a closed cell foam sheet and an open cell foam sheet.

5-6. (canceled)

7. The composite material of claim 1, wherein the flame retardant layers comprise inorganic paper materials or mica-based materials.

8. The composite material of claim 1, wherein the at least one radiant barrier layer comprises one of a metal foil and a metal foil tape.

9. The composite material of claim 1, further comprising an adhesive to bond one or more layers in the composite material together.

10-13. (canceled)

14. The composite material of claim 1, wherein the composite material has a thickness of between 0.5 mm and 5 mm.

15. The composite material of claim 1, wherein the composite material has an elastic compressibility less than 10 psi, when compressed to a thickness of 2 mm.

16. (canceled)

17. The composite material of claim 1, wherein the composite material has a low side temperature of less than or equal to 140° C., when a high side temperature is 600° C., when the composite material is exposed to a heat source on one side of the composite material.

18. The composite material of claim 1, wherein the composite material has a low side temperature, T₂, is less than or equal to 25% of the high side temperature, T₁, when the composite material is exposed to a heat source on one side of the composite material.

19. The composite material of claim 1, wherein the composite material has a z-axis thermal conductivity of less than 0.25 W/m-K.

20. The composite material of claim 1, wherein the porous core layer is a thermally expandable layer having first and second major surfaces.

21-22. (canceled)

23. A thermal barrier composite material comprising:
a porous core layer wherein the porous core layer is a thermally expandable layer having first and second major surfaces;
a radiant barrier layer disposed on the first major surface of the thermally expandable layer; and
a flame barrier layer disposed on a second surface of the radiant barrier layer opposite the thermally expandable layer.

24. The thermal barrier composite material of claim 23, wherein the thermally expandable layer comprises a porous material that comprises a woven or nonwoven mat material having an expandable substance dispersed therein.

25. The thermal barrier composite material of claim 24, wherein the expandable substance is vermiculite.

26. The thermal barrier composite material of claim 23, wherein the radiant barrier is a metal foil or sheet.

27-28. (canceled)

29. The thermal barrier composite material of claim 23, further comprising a second flame retardant layer deposed on the thermally expandable layer opposite the radiant barrier layer.

30. The thermal barrier composite material of claim 23, wherein the first flame retardant layer is a mica tape or an inorganic paper.

31-32. (canceled)

33. The thermal barrier composite material of claim 23, wherein the thermally expandable layer has an expansion factor of at least 2.
